(19) United States
(12) Patent Application Publication
(10) Pub. No.: US 2004/0154315 A1
(43) Pub. Date: Aug. 12, 2004

(54) Method for vaporizing and heating compressed liquefied gases

(76) Inventor: Robert E. Bernert, Dartmouth, MA (US)

Correspondence Address: Robert J. Doherty Esq., 11 George St., Barrington, RI, 02806, US

(21) Appl. No.: 10/757,944

(22) Filed: Jan. 15, 2004

Related U.S. Application Data
(60) Provisional application No. 60/445,698, filed on Feb. 10, 2003.

(51) Int. Cl. F17C 9/02

(52) U.S. Cl. 62/50.2

(57) ABSTRACT

This invention provides an improved method for vaporizing and heating compressed liquefied gas and pressurized cryogenic fluids by using a pressure reduction system to control the vaporization pressure and temperature. By using this pressure management system, the vaporization temperature is reduced permitting a lower temperature-heating medium such as ambient air or ambient water to be used to effect full vaporization and super heating of the compressed liquefied gas.

Applicant claims the benefit of U. S. Provisional Patent Application Ser. No. 60/445,698 filed Feb. 10, 2003.

### BACKGROUND OF THE INVENTION

The present invention relates generally to a method for vaporizing and superheating compressed liquefied fluids. More particularly, the process of the instant invention provides a method for vaporizing compressed liquefied gases that are stored as liquids at or above their saturation point by reducing the liquid pressure and hence it's temperature by the Joule Thompson effect on gases and liquids prior to entering the fluid vaporizer. The teachings of the instant invention are particularly applicable to the vaporization and super heating of compressed liquefied gases and pressurized cryogenic fluids using lower temperature heating mediums such as ambient air and lower temperature water.

Liquefied gases and compressed liquefied gases such as carbon dioxide, propane, liquefied natural gas, and ammonia find wide use in a variety of applications. These gases are typically produced by compression and subsequent liquefaction. Many users of such liquefied gases have found it convenient to maintain on-site pressurized liquid storage tanks at ambient temperature or refrigerated and pressurized liquid storage tanks. The users then vaporize the liquid by adding heat as requirements dictate. The vaporized liquid is then piped to the gas use location or the gas distribution pipe header.

In the case where vapor is withdrawn from a liquefied gas storage tank, the tank pressure must be maintained using a pressure build-up vaporizer. Without this vaporizer, the fluid may become too cold or the pressure too low for the distribution of the vapor delivery process to continue. In some cases, such as propane, larger or multiple tanks are employed to prevent these problems.

Generally, the lower the temperature of the heat source, such as steam or electricity, the lower the cost of the energy. In the case of an existing vaporization system, reducing the temperature of the fluid being vaporized, the temperature difference between the fluid being vaporized and the heating medium is increased thereby increasing the capacity of the vaporizer.

An atmospheric vaporizer vaporizes liquids employing heat from the ambient air or ambient water, cooling water or seawater. The reason why atmospheric vaporizers are not generally used for compressed liquefied gases is because these liquids are stored at or near ambient temperatures rendering the heat transfer process essentially ineffective especially in colder climatic conditions. In many situations, such atmospheric vaporizers are employed in the warmer summer months when the air temperature is higher. In colder winter months, a supplemental heated type vaporizer is added increasing cost and complexity. Typically, atmospheric vaporizers are comprised of a series of pipes, tubes or finned tubes connected together and arranged either vertically or horizontally. Air units are generally vertical while water units are generally horizontal.

To extract heat from the heating medium such as ambient air or ambient water to effect the vaporization and super heat of the compressed liquefied gas, the aforementioned heating medium must be at a temperature greater than the fluid to be vaporized. The greater the temperature difference is, the more effective the vaporizing process will be. However, since the compressed liquefied gases are stored in their pressurized liquid vessels at or near ambient temperature, atmospheric vaporizers prove generally ineffective. For this reason, atmospheric vaporizers are generally not preferred for the vaporization of compressed liquefied gases. Instead, a vaporizer is employed which utilizes a source of heat other than or in addition to ambient heat. This heat source or energy such as steam or electricity has a much higher temperature. Due to the cost of these higher forms of energy, it is desirable to vaporize stored compressed liquefied gases using ambient heat under wider climatic conditions with drastic decrease in operating efficiency characteristic of prior art atmospheric vaporizers.

### OBJECT OF THE INVENTION

Accordingly, it is an object of this invention to provide an improved atmospheric vaporizer system for compressed liquefied gases.

It is another object of this invention to provide an improved air atmospheric vaporizer that is suitable for operation at all atmospheric climate zones.

It is another object of this invention to provide atmospheric air vaporizers which are suitable for operation to increase the gas delivery rate of atmospheric storage vessels which have been cooled below the atmospheric temperature during the gas delivery process.

It is another object of this invention in the case particular to carbon dioxide (CO₂) to provide an improved atmospheric vaporizer substantially avoiding the problem of solid/slush formation when the CO₂ is depressurized at about 60 PSIg (the triple point). The solid/slush mixture easily clogs lines and valves and, accordingly, most prior art did not vaporize very cold liquid CO₂.

It is another object of this invention to increase the temperature difference between the heating medium and the fluid being vaporized.

It is another object of this invention to maintain the pressure in liquefied gas storage tanks with an improved or greater temperature difference between the heating medium and the pressurized stored liquid.

### SUMMARY OF THE INVENTION

These and other objects of the invention are achieved by providing a means to reduce the vaporizing temperature of a stored compressed liquefied gas or cryogenic fluid by the law of isenthalpic expansion via a pressure control means and further in the case of carbon dioxide by adding a further vaporizing pressure control to prevent solid carbon dioxide formation when approaching the triple point.

The pressure control means reduces the pressure and hence the boiling temperature of the compressed liquefied gas before the fluid enters the vaporizer, which allows the vaporizing process to occur at a lower temperature within the vaporizer. Additionally, where the vaporizing pressure and/or temperature is/are desired to be further controlled such as triple point avoidance in the case of liquid carbon dioxide, a second pressure control means is added at the outlet of the vaporizer to prevent inadvertent pressure and/or temperature reduction due to gas distribution line pressure fluctuations.

Other objects, features and advantages of the invention shall become apparent as the description thereof proceeds when considered in connection with the accompanying illustrative drawings.

### DESCRIPTION OF THE DRAWINGS

In the drawings which illustrate the best mode presently contemplated for carrying out the present invention:

FIG. 1 (Sketch S57-1P) shows the Press-Trol system of the present invention as set up for Carbon Dioxide with both vaporizer inlet pressure control (to reduce vaporizing temperature) and back pressure control in the vaporizer to prevent solid/slush CO₂ forming as the reduced operating pressure nears the CO₂ triple point.

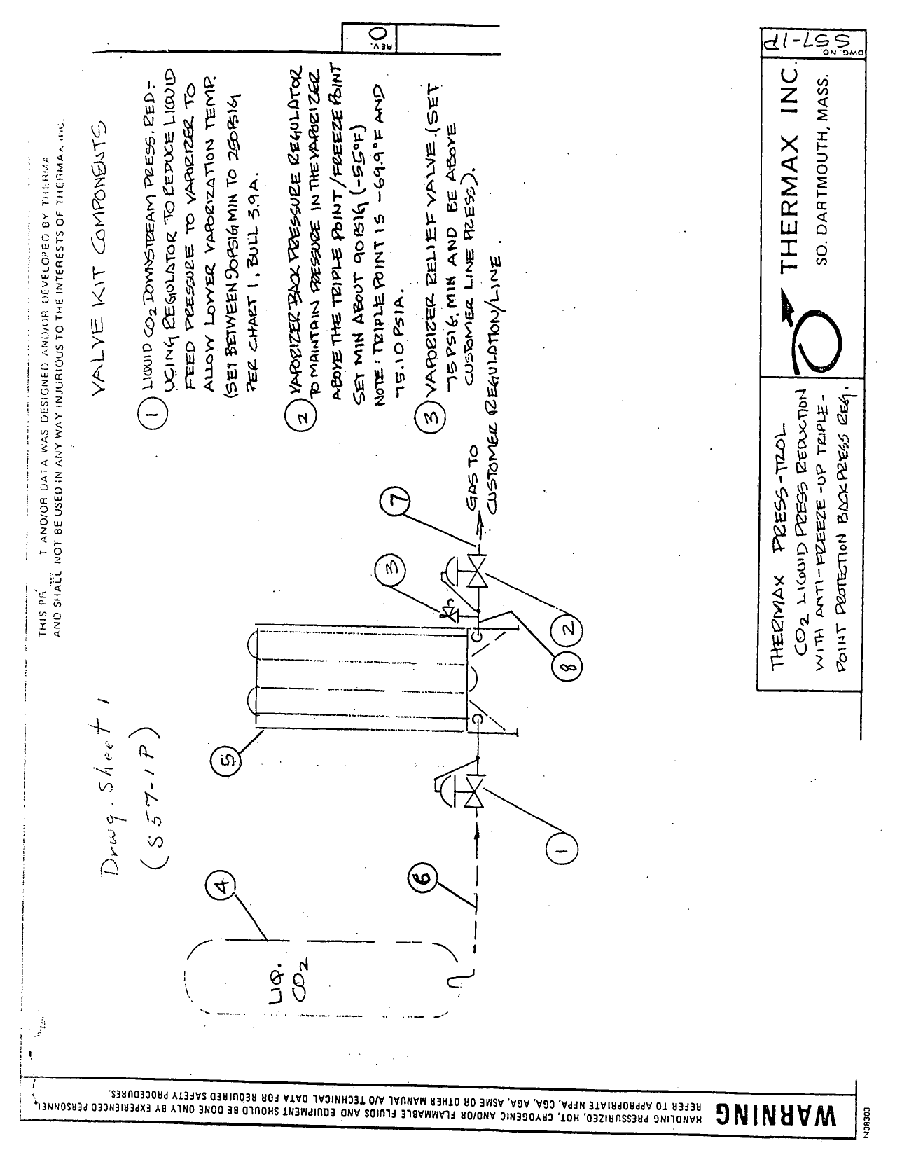

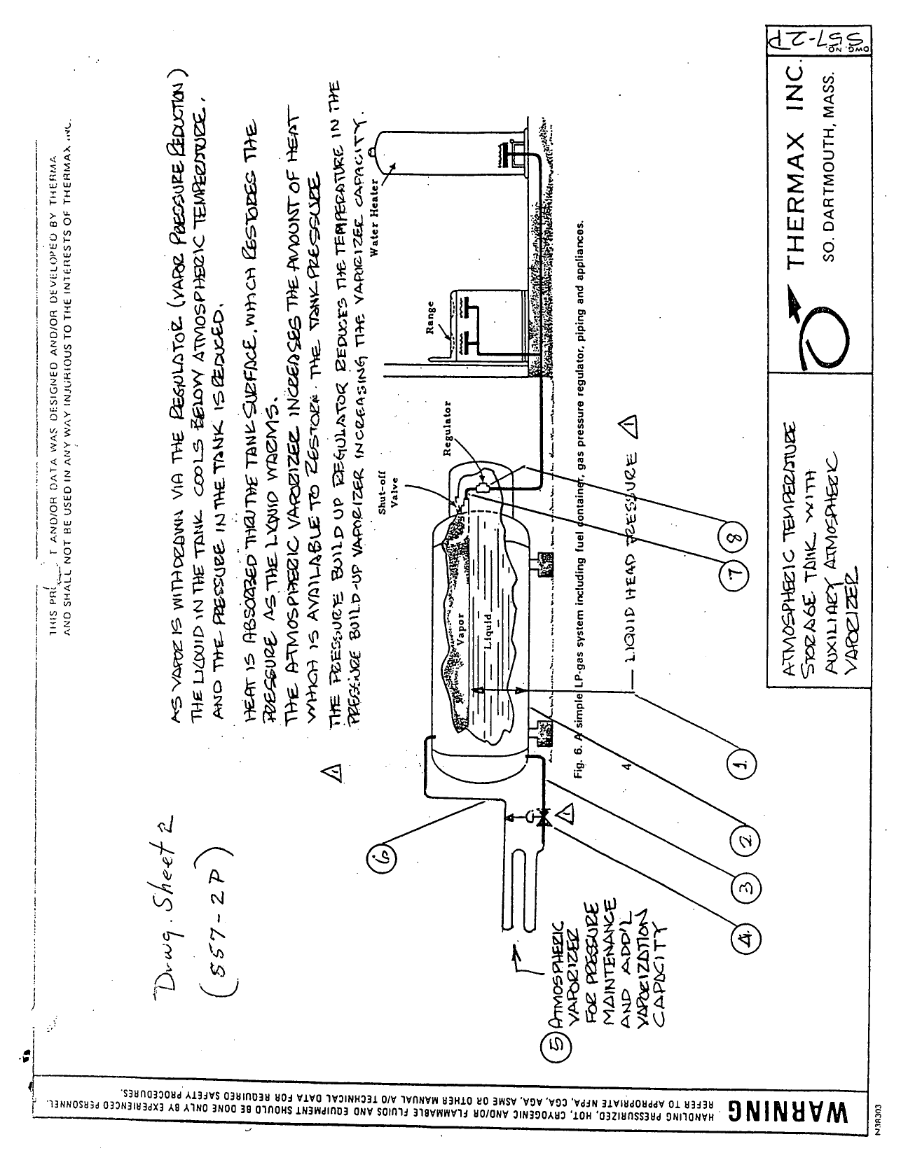

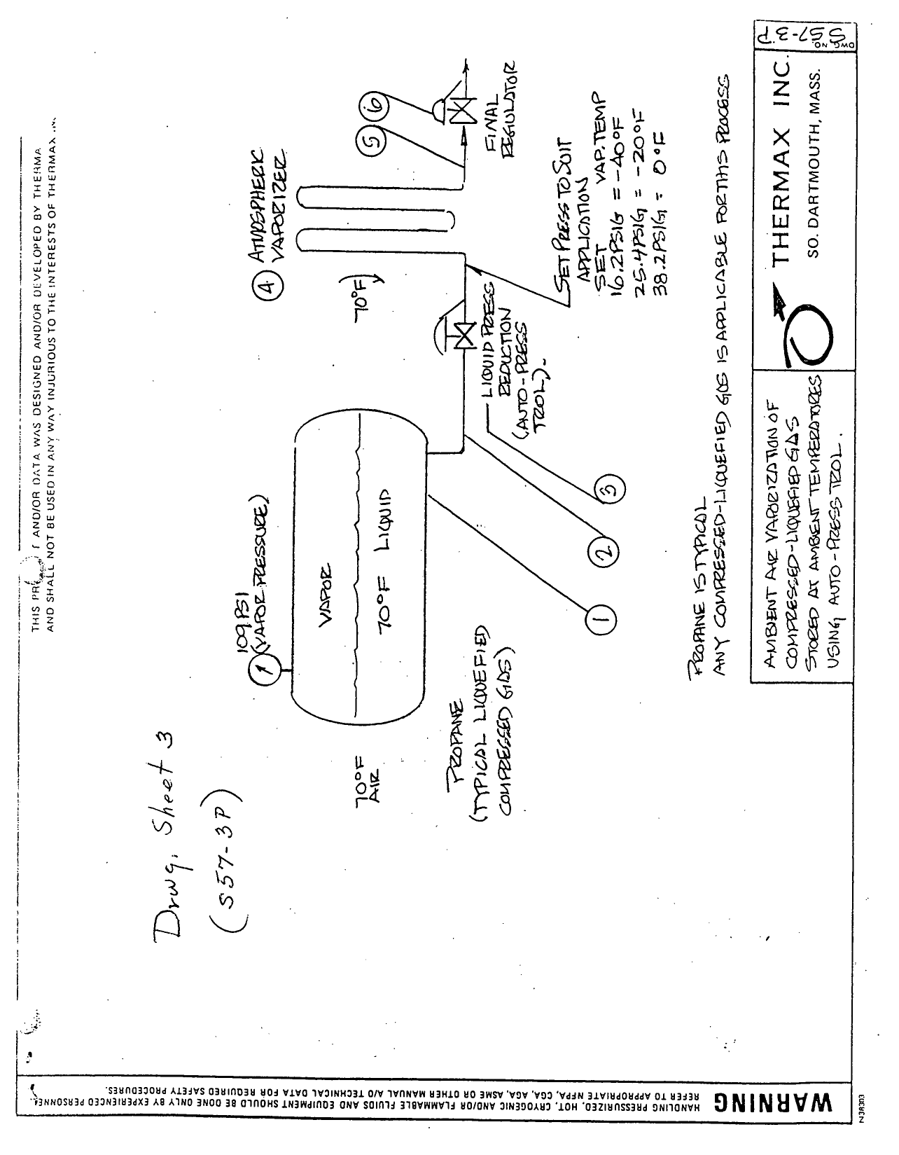

In this embodiment, compressed liquefied carbon dioxide is stored in pressurized tank 4. As the liquid carbon dioxide flows in the liquid withdrawal line 6, the pressure of such liquefied gas is reduced via the liquid pressure reduction valve 1 before entering vaporizer 5. At the lower pressure, which has a corresponding lower boiling temperature, the liquefied gas is more easily vaporized before entering the customer/gas distribution line 7. To further control the vaporizing pressure and temperature back pressure control, regulator 2 is placed in the vaporizer exit line 8. Pressure relief valve 3 protects the vaporizer from excess pressure in the event of distribution line 7 close off by allowing excess vaporized liquid to escape from the vaporizer. In the case of liquid carbon dioxide, the vaporizer 5 is maintained above the triple point of 75.10 PSIA, corresponding to a boiling temperature of −69.9° F.

FIG. 2 (Sketch S57-2P) shows a modified Press-Trol system to permit higher vaporization of an atmospheric temperature compressed liquefied gas storage tank using atmospheric vaporizer.

In this embodiment, compressed liquefied propane is stored in a tank 10 at atmospheric temperature at the corresponding pressure. As vapor is withdrawn for use via supply line 12 and customer control pressure regulator 14, the pressure and liquid temperature within the tank 10 is lowered. When the temperature within the tank drops below the instant atmospheric temperature surrounding the tank, heat from the air transfers into the tank 10 since the uninsulated tank is colder than the instant air temperature. This heat transfer may restore the tank pressure or reach equilibrium some degrees below the atmospheric temperature. At high vapor withdrawal rates, auxiliary heat may be provided externally via a pressure maintenance vaporizer 16. Since a liquid head 18 within the tank has a corresponding pressure head, for example, 6 feet of liquid propane has a pressure head of about 1.33 PSI, the boiling point within the external vaporizer 16 may be reduced a corresponding boiling temperature of about 2.5° F. by placing a liquid pressure reduction valve 20 into the liquid line 22 feeding vaporizer 16. Vaporized pressure maintenance vapor re-enters the tank via line 24. In effect, an atmospheric vaporizer 16 which has an area exposed to the ambient air equal to the external surface of tank 10 can double the gas withdrawal rate of the tank.

FIG. 3 (Sketch S57-3P) shows a Press-Trol system of the present invention used to reduce the vaporizing temperature to permit vaporization with atmospheric temperature air of a compressed liquefied gas stored at atmospheric temperature.

In this embodiment, compressed liquefied gas is stored in tank 30 at near the temperature of the vaporizing heating medium. Before entering the vaporizer 28, the liquefied gas is passed via line 32 through liquid pressure reduction valve 34 thereby reducing its boiling point. The pressure/boiling temperature reduction provides a greater temperature difference between the vaporizing temperature and the heating medium thereby increasing capacity. Such an increase when ambient air is used as the heating medium improves the process. Also since atmospheric temperature fluctuates both daily and seasonally, final pressure regulators 36 are placed in gas distribution line 38. Thus by increasing the difference between the vaporizing temperature of the compressed liquefied gas and the temperature of the ambient air available to supply heat to vaporize the liquefied gas, the lower ambient temperatures normally present in colder climate areas are adequate to enable operation of atmospheric vaporizers with no or less added heat supply as by electricity necessitated, thus reducing vaporization costs.

While there is shown and described herein certain specific structure embodying this invention, it will be manifest to those skilled in the art that various modifications and rearrangements of the parts may be made without departing from the spirit and scope of the underlying inventive concept and that the same is not limited to the particular forms herein shown and described except insofar as indicated by the scope of the appended claims.

What is claimed is:

1. An improved method of vaporizing a compressed liquefied gas stored in a tank at atmospheric temperature with an atmospheric temperature air vaporizer and through which said gas passes for vaporization thereof by utilizing the heat of the ambient air, comprising the step of passing said liquefied gas through a liquid pressure reduction valve so as to reduce its boiling point prior to passing said gas through said vaporizer.

2. The method of claim 1, wherein passing said liquefied gas through said liquid pressure reduction valve increases the difference between the vaporizing temperature of the compressed liquefied gas and the temperature of the ambient air available to supply heat to vaporize said liquefied gas.

3. The method of increasing the vaporization rate of a compressed liquefied gas stored in an uninsulated tank at atmospheric temperature including and having gas in a liquid phase with gas in a vapor phase thereabove including the steps of withdrawing vaporized gas via a supply line having a pressure control regulator thus allowing the pressure and liquid temperature within the tank to be lowered below the atmospheric air temperature surrounding the tank and thence the pressure within the tank allowed to use as the ambient air heat passes through the tank to subsequently raise the temperature of the gas, comprising placing a secondary external vaporizer in the system separate from said supply line so as to increase the rate of heat transfer from the ambient air to said gas stored in said tank.

4. An improved method of vaporizing liquefied carbon dioxide stored under pressure in a tank wherein said liquid carbon dioxide is passed through a vaporizer and thence withdrawn in a gaseous state via an exit line, the improvement comprising passing said liquefied carbon dioxide through a liquid pressure reduction valve so as to reduce its boiling point prior to passing said gas through said vaporizer and simultaneously controlling the vaporizing pressure within the vaporizer above the triple point of carbon dioxide so as to prevent formation of solid carbon dioxide from forming.

5. The method of claim 4 wherein the vaporizing pressure is controlled by a backpressure control regulator in the exit line.

6. The method of claim 5 including a pressure relief valve positioned between the vaporizer and the backpressure control valve.

7. The method of claim 5 wherein the vaporizing pressure within the vaporizer is maintained above 75.10 PSIA corresponding to a boiling temperature of −69.9° F.
